(19) United States
(12) Patent Application Publication
(10) Pub. No.: US 2010/0198509 A1
(43) Pub. Date: Aug. 5, 2010

(54) 3D MAPS RENDERING DEVICE AND METHOD

(75) Inventors: Paolo Orsatti, Melide (CH); John Owen Cook, Suffolk (GB)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/599,228

(22) PCT Filed: Jun. 4, 2008
(86) PCT No.: PCT/EP08/56886

§ 371 Date: Nov. 6, 2009

(30) Foreign Application Priority Data
Jun. 7, 2007 (EP) 07109831.3

(51) Int. Cl. G01C 21/26; G01S 19/42

(52) U.S. Cl. 701/212; 701/208; 701/207

(57) ABSTRACT

The invention uses altitude, determined from a GPS receiver, or GPS receiver with additional sensor input, to provide additional input to the map rendering application or to a pointer device. The advantage lies in improving the user experience in particular situations where map rendering using horizontal position from GPS plus a default altitude gives a distorted view when compared with the true viewing angle. Providing altitude in addition to the horizontal position, in conjunction with image rendering that can use the additional input will correct this shortcoming

### FIELD OF THE INVENTION

The present invention is concerned with methods to render three-dimensional maps and, in particular, rendering methods applicable to a navigation assistance device. Embodiments of the present invention further concern methods to generate a live three-dimensional display on a visualization device, including three-dimensional features for enhanced navigation and ease of use. The invention also concerns a navigation device realizing the above methods.

### DESCRIPTION OF RELATED ART

Satellite assisted navigation is increasingly used both on-road and off-road vehicles and applications. Recent implementations of satellite navigation products have included the capability for 3D rendering of maps, particularly cities, where the display of buildings along the route is of great assistance to users. At present, however the rendering of 3D features in maps in navigation assistance devices is limited to the use of a 2D horizontal position to determine viewing angle.

GPS enabled devices that includes an attitude determination system (azimuth and elevation angle) are also known. Such devices, for example integrated in a binocular or in an optical instrument, can be used to point objects (buildings, point of interest, star) so that a remote location can be identified and specific information about it can be requested to a LBS system.

The limitation of the current technology lies in the use of a 2D position for determining viewing angle. While this is adequate for the most driving situations, there will be many occasions when the viewing position differs greatly from the default ground level and known rendering algorithms will fail to provide a realistic image. Possible scenarios in which the known rendering algorithms will fail include multi-level roads, inside multi-level parking structures or in any number of pedestrian or other non-vehicular situations.

There is therefore a need for a rendering technique which can provide accurate 3D representations, even in complex scenarios as noted above. It is an aim of the present invention to provide a rendering algorithm and device which can provide accurate 3D representations even in scenario which exceed the rendering capability of known methods and devices.

### BRIEF SUMMARY OF THE INVENTION

According to the invention, these aims are achieved by means of the method and device which are the object of the appended claims. In particular, these aims are achieved a rendering technique that uses altitude to determine viewing angle will be of great benefit in aligning a user's view with that of the location-based device.

### BRIEF DESCRIPTION OF THE DRAWINGS

The invention will be better understood with the aid of the description of an embodiment given by way of example and illustrated by the figures, in which:

FIGS. 1 and 2 show schematically two possible implementations of the present invention.

### DETAILED DESCRIPTION OF POSSIBLE EMBODIMENTS OF THE INVENTION

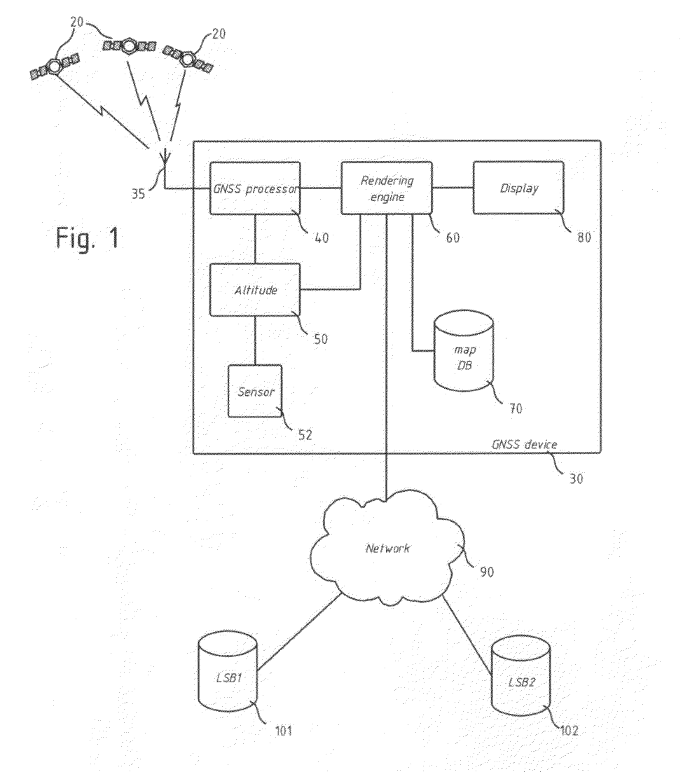

According to FIG. 1, the invention relates to a satellite radiolocalization device 30 which is able to receive, by antenna 35, modulated radio data from a constellation of satellites 20, and comprises a GNSS processor 40 to extract radiolocalization information from the received data. Known radiolocalization systems include, but are not limited to, GPS (Global Positioning System), Glonass and Galileo satellite system. The radiolocalization device 40 includes also a RF front-end (not represented) to receive a radiofrequency signal from satellites 20, and condition it in a format suitable for processor 40, for example as a baseband or low-IF carrier-stripped signal in digital or analogue format.

The invention will be further described in the context of a typical navigation assistance application, in which the device 30 provides guidance to the conductor of a vehicle (e.g. a car) in which the device 30 is installed, in order to complete a predefined route, or reach a predefined destination, on a road network. It must be kept in mind, however, that the invention is not limited to such application, which is given here by way of example only.

GNSS device 30 could be implemented as a standalone car navigator, or as a hand-held autonomous device, for example a GPS device for outdoor activities. According to variants of the present invention, GNSS device 30 could be a portable phone or PDA comprising a GNSS radiolocalization circuit, or could be replaced by a system including several components or modules belonging to a suitable communication network. For example a phone or PDA having access, via a Bluetooth link, to a GNSS processor implemented as a separate unit.

GNSS processor 40 provides, in known way, a series of positioning data, or fixes, which represent the position of receiver 70 in a suitable cartographic reference system. The stream of positioning data 41 is transmitted to a rendering engine 60, which has access to location data, either stored in a local map database 70, or obtained by external location based servers LBS1 and LBS2, via a suitable network 90, for example a wireless telephone network.

Rendering engine 60 builds on display 80 a virtual representation of the visible scene, for example the scene visible to the driver of vehicle, including map data 70 and/or data from LBS1 and LBS2, according to positioning data 41. The representation includes 3D elements, for example 3D representation of buildings and terrain, as well as visual clues relative to the route that ought to be followed in order to arrive at the selected destination. Preferably the navigation device 30 also includes a module to generate vocal route instructions (not represented).

In order to increase the realism, and provide a maximum of useful information to the driver, rendering engine 60 relies on altitude data 42, provided from an altitude determination module 50. According to the circumstances, altitude data 42 may be obtained from radiolocalization signals from satellites 20, or from a separate sensor unit 52, for example an atmospheric pressure sensor. Altitude determination module 50 may, according to the circumstances, be realized as a separate hardware unit, or as a software module, executed by a microprocessor, possibly a common processor with the GNSS processor 40.

A combination of an atmospheric pressure sensor and a GPS receiver can provide very precise altitude data. The accuracy of the altitude given by a GPS receiver is around ±10 meters in open sky conditions, but can grow to more than ±200 meters in urban environment. In difficult receiving conditions, moreover, GPS altitude determinations are affected by large spikes. The accuracy of the pressure-based altitude measurement, on the other end, is in the region of ±1 meter and is very precise during the time, provided it is calibrated for the atmospheric pressure variations. This can be done effectively by using average GPS altitude data. Due to slow pressure changes, calibration is usually valid for at least 30 min-1 hour.

According to an independent aspect of the invention, the GNSS processor 40 and the altitude-determination module 50 are realized as a common unit, and preferably as a single integrated circuit having a common processor, GNSS processing 40 and altitude determination 50 being provided as software modules. The invention covers also a GNSS processor including an altitude-determination module realized in a common unit, preferably in a single integrated circuit, and having an input for an external altitude sensor, for example an atmospheric pressure sensor. According to this aspect of the invention, the altitude-determination module is preferably programmed to calibrate the pressure-based altitude determination, based on the average GPS altitude data.

In a variant, the invention uses altitude, determined from a GPS receiver, or GPS receiver with additional sensor input, to provide additional input to a handheld pointer device. If the handheld device does not know his accurate altitude it is difficult to establish an unequivocal correspondence with the 3D objects stored in the device's database, especially when there are many possible objects to point to in the line of sight. Typical examples are pointing to an object from inside a city with many possible points of interest in the line of sight, in which case not knowing the accurate altitude may reduce the probability that the object you intend is the object the device has ‘identified’.

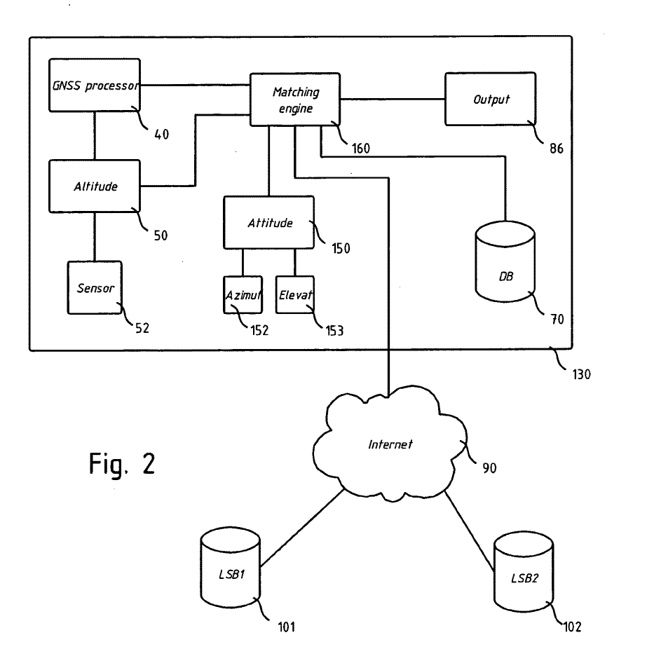

The functioning of a pointer device 130 according to one aspect of the invention will be now described with reference to FIG. 2. The pointer device would preferably be part of a cell phone or of a PDA device, but it could also be realized as a standalone unit.

Pointing device 130 is conformed as to allow aiming at selected targets by the user. This could be done by aligning the target with a set of sights on the device, for example. In the case of a cell phone, however, the bearing of a target is preferably taken by aiming at it with the camera included in the phone. Other aiming methods are however available and included in the scope of the present invention.

Compared to the navigation assistant 30 represented in FIG. 1, the pointing device 130 includes an azimuth sensor 152, and an inclination sensor 153, connected to an attitude module 150, which provides the bearing and elevation of the target, relative to the device position. Azimuth sensor 152 could include, for example, a solid-state magnetic compass, and inclination sensor 153 may be based on a clinometer or on an accelerometer.

Matching unit 160 is sensitive to position data 41 and to altitude data 42, and to attitude data 43. By combining these data, matching unit 160 is able to identify the target at Which the pointing device is aiming, among a collection of possible targets stored in the local database 70, or provided by the LBS servers 101 and 102, accessible to the pointing device 130 by means of a suitable wireless internet link 90, for example. Reliability of target identification is much enhanced by the knowledge of altitude data 42.

Upon identification of the target, the pointing device 130 can provide target-related information on the output unit 85. These can include a 3D model of the target, but also other contents, available from local database 70 and from remote servers 101, 102. For the output unit could provide, for example, general information on the target, opening hours, commercial information, links to internet pages related to the target, telephone numbers, email addresses, and so on.

1. A three-dimensional map rendering device (30), including a GNSS processor (40), an altitude determination module (50), and a rendering engine (60) having access to location data stored in one or more databases (70, 101, 102), the rendering engine being arranged to reproduce, on a display unit 80, a virtual representation of the visible scene, based on position data (41) provided by the GNSS processor (40) and on altitude data (42) provided by the altitude module (50).

2. The three-dimensional map rendering device of claim 1, wherein the altitude data (42) are obtained from the position data (41).

3. The device of claim 1, wherein the altitude data (42) are obtained from an altitude sensor (52), for example an atmospheric pressure sensor.

4. The device of any of the previous claims, wherein the virtual representation reproduced on display 80 comprises three-dimensional representations of buildings or of terrain.

5. The device of any of the previous claims, wherein the virtual representation reproduced on display 80 is generated as seen by a virtual eye point whose position is derived from position data (41) and whose altitude is derived from altitude data (42).

6. A method of rendering a virtual representation of a scene comprising the steps of:
obtaining position data (41) from a satellite radiolocalization module (40) and altitude data from an altitude determination module (50),
retrieving, from one or more map databases (70, 101, 102) descriptive data of features visible from a notional eye point corresponding to said position data (41) and altitude data (42),
rendering, on a visualization display (80) said features as seen from said notional eye point.

7. The method of the previous claim, wherein said features comprise roads and/or buildings and/or terrain data.

8. A method of providing position-related information comprising the steps of:
aiming at a selected target with a pointing device (130), the pointing device (130) containing satellite radiolocalization means, (40), altitude determination means (50), and attitude determination means (150),
identifying the target, based on position data provided by said radiolocalization means, altitude data provided by said altitude determination means (50), and attitude data provided by said attitude determination means (150),
obtaining target-related information from one or more databases (70, 101, 102)
displaying said target-related information.

9. Data processor for a GNSS radiolocalization system, comprising an altitude determination input and an altitude input for an external altitude sensor.

10. The data processor of the previous claim, characterized by being realized as a single integrated circuit.
